(19) United States
(12) Patent Application Publication
(10) Pub. No.: US 2023/0086114 A1
(43) Pub. Date: Mar. 23, 2023

(54) ACTION RECOGNITION DEVICE AND METHOD AND ELECTRONIC DEVICE

(71) Applicant: FUJITSU LIMITED, Kawasaki-shi (JP)

(72) Inventor: Wenting CAI, Beijing (CN)

(73) Assignee: FUJITSU LIMITED, Kawasaki-shi (JP)

(21) Appl. No.: 17/888,507

(22) Filed: Aug. 16, 2022

(30) Foreign Application Priority Data
Sep. 18, 2021 (CN) 202111097743.1

(51) Int. Cl. G06V 40/20; G06V 40/10; G06T 7/70; G06V 10/25; G06V 10/771

(52) U.S. Cl. CPC G06V 40/20; G06V 40/103; G06T 7/70; G06V 10/25; G06V 10/771; G06T 2210/12; G06V 2201/07

(57) ABSTRACT

Embodiments of this disclosure provide an action recognition device and method and an electronic device. The method includes: performing key point recognition on an object in a video frame by using a neural network to Obtain key point information and part affinity field score(s) of the object; performing key point connection according to the key point information and the part affinity field score(s); generating multiple key point connection candidates according to a result of the key point connection; for at least two of the multiple key point connection candidates, determining whether one of the at least two key point connection candidates is valid, so as to perform selection on the multiple key point connection candidates; and performing action recognition on the object according to the selected key point connection candidates. Hence, by selecting the generated key point connection candidates, accurate of action recognition in a bottom-up scheme may be improved.

### CROSS-REFERENCE TO RELATED APPLICATION

This application claims priority from Chinese Application No. 2021110977411, filed Sep. 18, 2021, the contents of which are incorporated by reference herein in its entirety.

### TECHNICAL FIELD

This disclosure relates to the field of video detection technologies.

### BACKGROUND

Currently, two strategies, top-down and bottom-up, can be used for action recognition (or pose estimation) of one or more objects in a video frame. In the top-down strategy, objects (such as human bodies) are first detected, and then a pose of each object is estimated independently on each detected image region; and in the bottom-up strategy, information on multiple key points (or key parts) is detected first, then these key points are connected to generate connection candidates, and the pose of each object is estimated based on these connection candidates.

Wherein, the bottom-up scheme includes, the example, the open source OpenPose, and associated scores may be used via a part affinity field (PAF). The PAF encodes positions and orientations of object parts (e.g. limbs) on an image domain and a confidence map (CMAP); and in the CHAP, a peak value corresponds to each visible part of each object (e.g. a human body).

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

However, it was found by the inventors that in an existing bottom-up scheme, for the same part of an object, repeated or erroneous key point connection candidates may possibly be generated according to a result of key point connection. If action recognition is performed according to the repeated or erroneous key point connection candidates, accuracy of results of action recognition of an object will be lowered.

Addressed to at least one of the above technical problems. embodiments of this disclosure provide an action recognition device and method and an electronic device, by which it is expected that accuracy of results of action recognition of an object in a bottom-up scheme may be improved.

According to an aspect of the embodiments of this disclosure, there is provided an action recognition device, including:

a key point recognition unit configured to perform key point recognition on an of in a video frame by using a neural network to obtain key point information and part affinity field (PAF) score(s) of the object;

a key point connection unit configured to perform key point connection according to the key point information and the part affinity field score(s);

a connection candidate generating unit configured to generate multiple key point connection candidates according to a result of the key point connection;

a connection candidate determining unit configured to, for at least two of the multiple key point connection candidates, determine whether one of the at least two key point connection candidates is valid, to perform selection on the multiple key point connection candidates; and

an action recognition unit configured to perform action recognition on the object according to the selected key point connection candidates.

According to another aspect of the embodiments of this disclosure, there is provided an action recognition method, including:

performing key point recognition on an object in a video frame by using a neural network to obtain key point information and part affinity field score(s) of the object;

performing key point connection according to the key point information and the part affinity field score(s);

generating multiple key point connection candidates according to a result of the key point connection;

for at least two of the multiple key point connection candidates, determining whether one of the at least two key point connection candidates is valid, to perform selection on the multiple key point connection candidates; and

performing action recognition on the object according to the selected key point connection candidates.

According to a further aspect of the embodiments of this disclosure, there is provided an electronic device, including a memory and a processor, the memory storing a computer program, and the processor being configured to execute the computer program to carry out the action recognition method described above.

An advantage of the embodiments of this disclosure exists in that for at least two key point connection candidates in the multiple key point connection candidates, whether one of the key point connection candidates is valid is determined, so as to perform selection on the multiple key point connection candidates, and action recognition of the object is performed according to the selected key point connection candidates. In this way, the generated key point connection candidates are re-selected, which mays improve accuracy of results of the action recognition in the bottom-up scheme.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

### BRIEF DESCRIPTION OF THE DRAWINGS

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of the action recognition method of an embodiment of this disclosure;

FIG. 2 is a schematic diagram of the key point connection candidates of an embodiment of this disclosure;

FIG. 3 another schematic diagram of the key point connection candidates of an embodiment of this disclosure;

FIG. 4 is a further schematic diagram of the key point connection candidates of an embodiment of this disclosure;

FIG. 5 is still another schematic diagram of the key point connection candidates of an embodiment of this disclosure;

FIG. 6 is yet another schematic diagram of the key point connection candidates of an embodiment of this disclosure;

FIG. 7 is a schematic diagram of adjusting bounding boxes of an embodiment of this disclosure;

FIG. 8 is a schematic diagram of the action recognition device of an embodiment of this disclosure; and

FIG. 9 is a schematic diagram of the electronic device action recognition device of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

Features that are described and/or illustrated with respect to one embodiment may be used in the same way or in a similar way in one or more other embodiments and/or in combination with or instead of the features of the other embodiments. The term “comprises/comprising” when used in this specification is taken to specify the presence of stated features, integers, steps or components but does not preclude the presence or addition of one or more other features, integers, steps, components or groups thereof.

In the embodiments of this disclosure, objects taken as detected objects may be human bodies of various ages, such as elderly persons or children, or elderly persons and/or caregivers, children and/or guardians. However, this disclosure is not limited thereto, and the objects taken as detected objects may be human bodies with vital features, or robots without vital features, or the like.

### Embodiments of a First Aspect

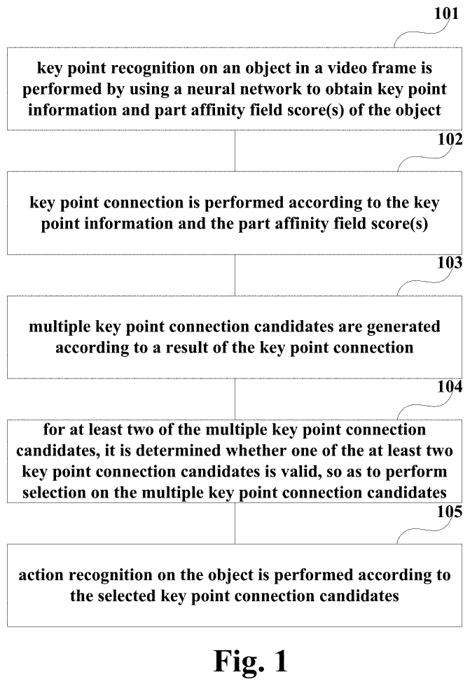

The embodiments of this disclosure provide an action recognition method. FIG. 1 is a schematic diagram of the action recognition method of an embodiment of this disclosure. As shown in FIG. 1, the method includes:

101: point recognition on an object in a video frame is performed by using a neural network to obtain key point information and. part affinity field score(s) of the object;

102: key point connection is performed according to the key point information and the part affinity field score(s);

103: multiple key point connection candidates are generated according to a result of the key point connection;

104: for at least two of the multiple key point connection candidates, it is determined whether one of the at least two key point connection candidates is valid, so as to perform selection on the multiple key point connection candidates; and

105: action recognition on the object is performed according to the selected key point connection candidates.

It should be noted that FIG. 1 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 1.

In some embodiments, a neural network based on ResNet or DenseNet, etc., may be used to perform key point recognition to obtain the part affinity field (PAF) information and confidence map information of the object; the key point information may be obtained according to the confidence map information; and the part affinity field score(s) between any two key points is calculated according to the part affinity field information and key point information. Reference may be made to related technologies for specific contents of the neural network, PAF, confidence map and PAF score(s).

In the embodiment of this disclosure, key point connection may be performed according to the key point information and pan affinity field score(s), and multiple key point connection candidates may be generated according to a result of the key point connection.

For example, a key point clustering algorithm may be used to apply a threshold (e.g. 0.1) to the confidence map to remove key points with low confidences and generate a binary map. Relationship pairs connecting a key point to other key points may be found, and a relationship with a smallest affinity between two key points may be taken as a final relationship pair. After traversing all relation pairs, key points of the same person are connected and a skeleton is drawn. Skeletons of multiple persons may be connected and assembled, thereby generating multiple key point connection candidates.

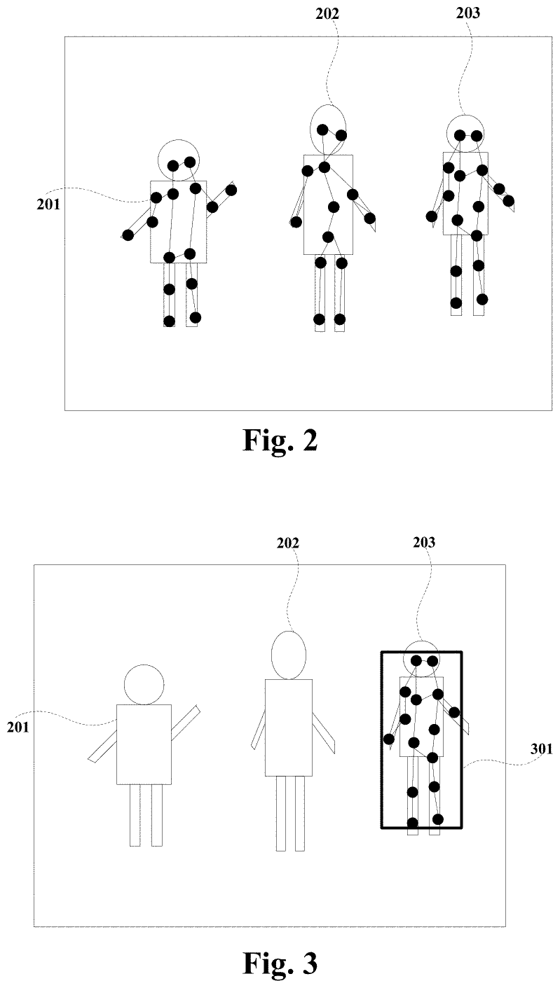

FIG. 2 is a schematic diagram of the key point connection candidates of an embodiment of this disclosure. As shown in FIG. 2. for example, there are 3 persons (shown by 201, 202 and 203) in the video frame. After such processing as key point recognition, etc., one or more key point connection candidates are generated for each person, One or more connected key points may be referred to as a key point connection candidate; however, it is not limited thereto.

In the embodiment of this disclosure, action recognition of the object may be performed based on the key point connection candidates. For example, action recognition (pose detection) of multiple persons may be performed based on OpenPose. However, if repeated or erroneous key point connection candidates are generated, accuracy of action recognition may possibly be greatly affected. For example, if four key point connection candidates are generated for the human body shown by 203 in FIG. 2 and these four key point connection candidates are partially repeated or even some of them are erroneous, it will lead to inaccurate subsequent action recognition.

In the embodiment of this disclosure, before action recognition is performed, multiple key to point connection candidates are selected, so that accuracy of the action recognition may further be improved. Selection of multiple key point connection candidates shall be exemplarily described below by taking that at least two key point connection candidates including a first key point connection candidate and a second key point connection candidate as an example.

In some embodiments, whether the first key point connection candidate is valid may be determined according to a position and size of the bounding box of the first key point connection candidate and a position and size of the bounding box of the second key point connection candidate.

For example, whether the bounding box of the first key point connection candidate is covered by the bounding box of the second key point connection candidate may be determined according to the positions and sizes of the bounding boxes. If the bounding box of the first key point connection candidate is covered by the bounding box of the second key point connection candidate, it may be determined that the first key point connection candidate may possibly be a subset of the second key point connection candidate, hence, the first key point connection candidate is a redundant part of the second key point connection candidate, and it may be determined that the first key point connection candidate is invalid, and then the first key point connection candidate may be discarded.

For another example, if an area of the bounding box of the first key point connection candidate is smaller than a preset threshold and an area of the bounding box of the second key point connection candidate is greater than or equal to the preset threshold, it may be determined that the first key point connection candidate may be a connection candidate caused by a result of erroneous detection, and the second key point connection candidate is a really correct connection candidate. Hence, it may be determined that the first key point connection candidate is invalid, and then the first key point connection candidate may be discarded.

In some embodiments, whether the first key point connection candidate is valid may be determined according to the number of key points of the first key point connection candidate and the number of key points of the second key point connection candidate.

For example, if the number of the key points of the first key point connection candidate is less than the number of the key points of the second key point connection candidate, it may be determined that the first key point connection candidate may possibly be a subset of the second key point connection candidate, hence, the first key point connection candidate is a redundant part of the second key point connection candidate, and it may be determined that the first key point connection candidate is invalid, and the first key point connection candidate may be discarded.

For another example, if the number of the key points of the first key point connection candidate is less than a preset threshold, and the number of the key points of the second key point connection candidate is greater than or equal to the preset threshold, it may be determined that the first key point connection candidate may possibly be a connection candidate caused by a result of erroneous detection, and the second key point connection candidate is really a correct connection candidate. Therefore, it may be determined that the first key point connection candidate is invalid, and then the first key point connection candidate may be discarded.

In some embodiments, whether the first key point connection candidate is valid may be determined according to the number of the key points and the position and size of the bounding box of the first key point connection candidate and the number of the key points and the position and size of the bounding box of the second key point connection candidate.

In particular, in a case Where the bounding box of the first key point connection candidate is covered by the bounding box of the second key point connection candidate, whether the number of the key points of the first key point connection candidate is less than a first proportion of a total number of key points of the object and whether the number of the key points of the second key point connection candidate is greater than a second proportion of the total number of key points of the object may be determined;

and in a case where the number of the key points of the first key point connection candidate is less than the first proportion of the total number of the key points of the object and the number of the key points of the second key point connection candidate is greater than the second proportion of the total number of the key points of the object, it is determined that the first key point connection candidate is invalid and the first key point connection candidate is discarded.

For example, it is as shown in Table 1:

```
  ∃kᵢ, kⱼ, kᵢ< α*K and kⱼ > β*K and , kᵢ < kⱼ
  If bboxᵢ is completely covered by bboxⱼ ,
  then discard the i^{th} “candidate”;
  where, kᵢ denotes the number of the key
  points of an i-th key point connection candidate,
kⱼ denotes the number of the key points of a
j-th key point connection candidate, bboxᵢ denotes
a bounding box of the i-th key point connection
candidate, bboxⱼ denotes a bounding box of
the j-th key point connection candidate, α denotes
a first proportion, β denotes a second
proportion, and K denotes a total number of key
points of the object, α, β and K being able
to be preset according to empirical values.
```

FIG. 3 is another schematic diagram of the, key point connection candidates of an embodiment of this disclosure, showing a key point connection candidate 301 (a second key point connection candidate) generated for the human body 203 in FIG. 2. As shown in FIG. 3, the key point connection candidate 301 has 15 key points connected to each other, and FIG. 3 shows a bounding box containing the 15 key points.

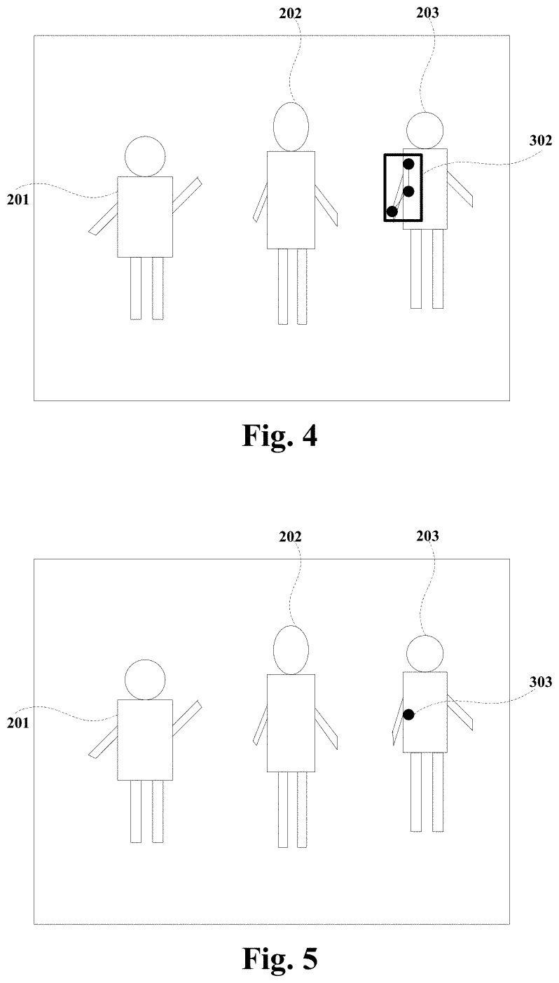

FIG. 4 is a further schematic diagram of the key point connection candidates of an embodiment of this disclosure, showing another key point connection candidate 302 (a first key point connection candidate) generated for the human body 203 in FIG. 2. As shown in FIG. 4, the key point connection candidate 302 has 3 key points connected to each other, and FIG. 4 shows a bounding box containing the 3 key points.

FIG. 5 is still another schematic diagram of the key point connection candidates of an embodiment of this disclosure, showing a further key point connection candidate 303 (a first key point connection candidate) generated for the human body 203 in FIG. 2. As shown in FIG. 5, the key point connection candidate 303 has one key point, and FIG. 5 does not show a bounding box containing the one key point.

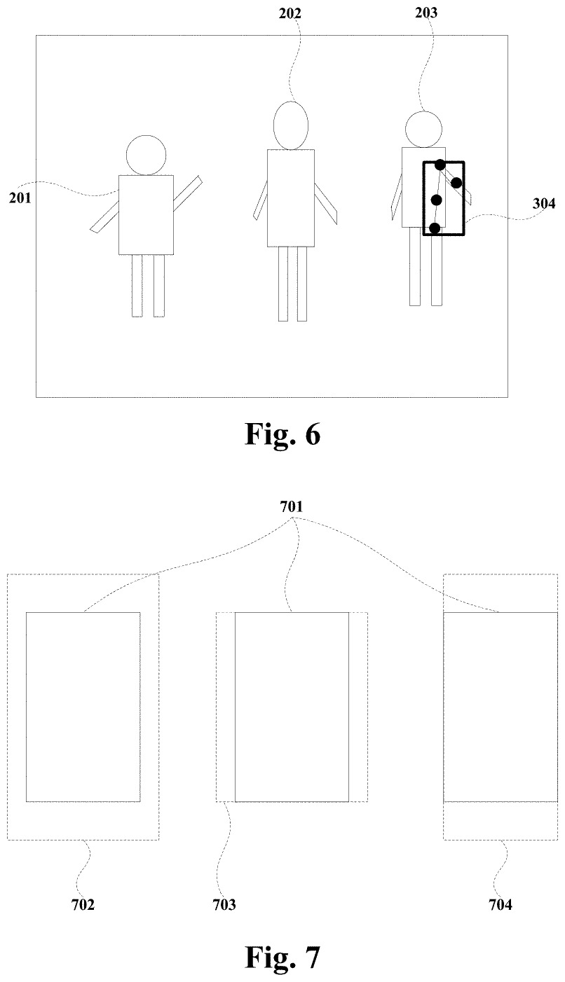

FIG. 6 is yet another schematic diagram of the key point connection candidates of an embodiment of this disclosure, showing still another key point connection candidate 304 (a first key point connection candidate) generated for the human body 203 in FIG. 2. As shown in FIG. 6, the key point connection candidate 304 has 4 key points connected to each other, and FIG. 6 shows a bounding box containing the 4 key points.

As shown in FIGS. 3 to 6, the key point connection candidates 301-304 are for the same human body 203 and may be selected according to the above scheme. For example, suppose K=18, α=⅓; β=⅔. However, this disclosure is not limited thereto, and specific values of these parameters may be set according to actual scenarios.

As to the key point connection candidate 301 and the key point connection candidate 302, the bounding box of the key point connection candidate 301 covers the bounding box of the key point connection candidate 302, and the number of the key points of the key point connection candidate 301 is 15, which is greater than 12 (18*⅔), and the number of the key points of the key point connection candidate 302 is 3, which is less than 6 (18*⅓), hence, the key point connection candidate 302 is discarded.

As to the key point connection candidate 301 and the key point connection candidate 303, the bounding box of the key point connection candidate 30) covers the bounding box of the key point connection candidate 303, and the number of the key points of the key point connection candidate 301 is 15, which is greater than 12 (18*⅔), and the number of the key points of the key point connection candidate 303 is 1, which is less than 6 (18*⅓); hence, the key point connection candidate 303 is discarded.

As to the key point connection candidate 301 and the key point connection candidate 304, the bounding box of the key point connection candidate 301 covers the bounding box of the key point connection candidate 304, and the number of the key points of the key point connection candidate 301 is 15, which is greater than 12 (18*⅔), and the number of the key points of the key point connection candidate 304 is 4, which is less than 6 (18*⅓); hence, the key point connection candidate 304 is discarded.

Therefore, selecting the key points according, to the number of the key points and the positions and sizes of the bounding boxes may filter out repeated or erroneous key point connection candidates more accurately, which may further improve the accuracy of action recognition.

In the embodiment of this disclosure, the bounding boxes may be directly obtained after such processing as key point detection and key point connection, etc., and in order to further improve the accuracy of selection of the key point connection candidates, the bounding boxes of the key point connection candidates may be appropriately adjusted.

In some embodiments, the bounding box of the first key point connection candidate is a smallest first rectangular box containing all key points in the first key point connection candidate, and the bounding box of the second key point connection candidate is a smallest second rectangular box containing all key points in the second key point connection candidate.

In some embodiments, the bounding box of the first key point connection candidate is a smallest first rectangular box containing all key points in the first key point connection candidate, and the bounding box of the second key point connection candidate is a rectangular box obtained by expanding longer sides of the second rectangular box by a proportion and/or by expanding shorter sides of the second rectangular box by a proportion.

FIG. 7 is a schematic diagram of adjusting bounding boxes of an embodiment of this disclosure, As shown in FIG. 7, 701 denotes the smallest rectangular box containing all key points, 702 denotes the rectangular box obtained by expanding longer sides of the rectangular box 701 by a proportion and by expanding shorter sides of the rectangular box 701 by a proportion, 703 denotes the rectangular box obtained by expanding shorter sides of the rectangular box 701 by a proportion, and 704 denotes the rectangular box obtained by expanding longer sides of the rectangular box 701 by a proportion.

The above describes only the steps or processes related to this disclosure; however, this disclosure is not limited thereto. The action recognition method may further include other steps or processes, and reference may be made to the prior art for particular contents of these steps or processes. Moreover, the embodiment of this disclosure is described above by taking some structures of the action model as an example. However, this disclosure is not limited to these structures, and appropriate modifications may be made to these structures, and implementations of these modifications should be included in the scope of the embodiments of this disclosure.

The embodiments of this disclosure are exemplarily described above; however, this disclosure is not limited thereto, and appropriate modifications may be made on the basis of the above embodiments. For example, the above embodiments may be used separately, or one or more of the above embodiments may be used in a combined manner.

It can be seen from the above embodiment that for at least two key point connection candidates in the multiple key point connection candidates, whether one of the key point connection candidates is valid is determined, so as to perform selection on the multiple key point connection candidates, and action recognition of the object is performed according to the selected key point connection candidates. In this way, the generated key point connection candidates are re-selected, which may improve accuracy of results of the action recognition in the bottom-up scheme.

### Embodiments of a Second Aspect

The embodiments of this disclosure provide an action recognition device, with contents identical to those in the first aspect being not going to be described herein any further.

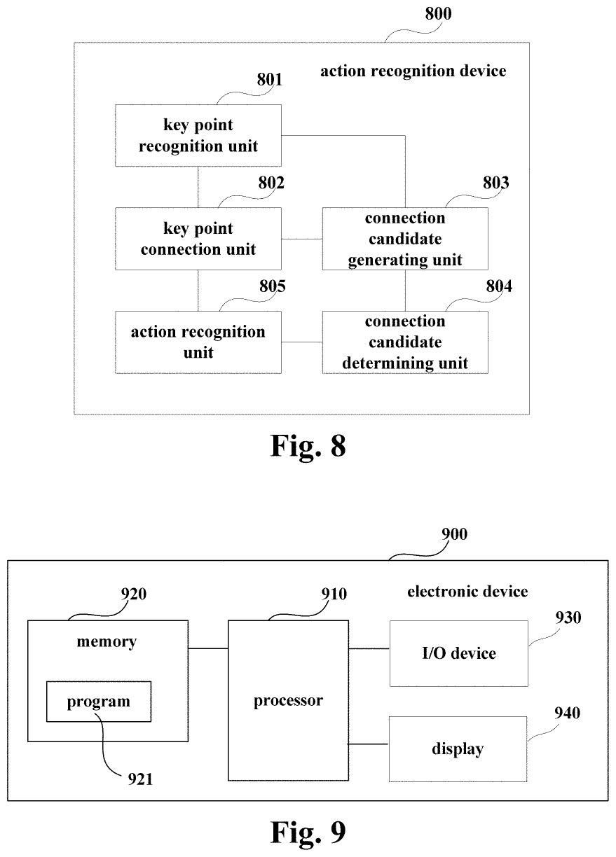

FIG. 8 is a schematic diagram of the action recognition device of an embodiment of this disclosure. As shown in FIG. 8, the action recognition device 800 includes:

a key point recognition unit 801 configured to perform key point recognition on an object in a video frame by using a neural network to obtain key point information and part affinity field (PAF) score(s) of the object;

a key point connection unit 802 configured to perform key point connection according to the key point information and the part affinity field score(s);

a connection candidate generating unit 803 configured to generate multiple key point connection candidates according to a result of the key point connection;

a connection candidate determining unit 804 configured to, for at least two of the multiple key point connection candidates, determine whether one of the at least two key point connection candidates is valid, so as to perform selection on the multiple key point connection candidates; and

an action recognition unit 805 configured to perform action recognition on the object according to the selected key point connection candidates.

In some embodiments, the key point recognition unit 801 is particularly configured to: obtain part affinity field information and confidence map information of the object according to the key point recognition; obtain the key point information according to the confidence map information; and calculate the part affinity field score(s) between any two key points according to the part affinity field information and the key point information.

In some embodiments, the at least two key point connection candidates include a first key point connection candidate and a second key point connection candidate.

In some embodiments, the connection candidate determining unit 804 is configured to determine whether the first key point connection candidate is valid according to a position and size of a bounding box of the first key point connection candidate and a position and size of a bounding box of the second key point connection candidate.

In some embodiments, the connection candidate determining unit 804 is further configured to: according to the number of key points of the first key point connection candidate and the number of key points of the second key point connection candidate, determine whether the first key point connection candidate is valid.

In some embodiments, the connection candidate determining unit 804 is particularly configured to: in a case where the bounding box of the first key point connection candidate is covered by the bounding box of the second key point connection candidate, determine whether the number of key points of the first key point connection candidate is less than a first proportion of a total number of key points of the object and determine whether the number of key points of the second key point connection candidate is greater than a second proportion of the total number of the key points of the object.

In a case where the number of key points of the first key point connection candidate is less than the first proportion of the total number of the key points of the object and the number of key points of the second key point connection candidate is greater than the second proportion of the total number of the key points of the object, it is determined that the first key point connection candidate is invalid and the first key point connection candidate is discarded.

In some embodiments, the bounding box of the first key point connection candidate is a smallest first rectangular box containing all key points in the first key point connection candidate;

and the bounding box of the second key point connection candidate is a smallest second rectangular box containing all key points in the second key point connection candidate, or the bounding box of the second keys point connection candidate is a rectangular box obtained by expanding longer sides of the second rectangular box by a proportion and/or by expanding shorter sides of the second rectangular box by a proportion.

It should be noted that the components or modules related to this disclosure are only described above. However, this disclosure is not limited thereto, and the action recognition device 800 may further include other components or modules, and reference may be made to related techniques for particulars of these components or modules.

For the sake of simplicity, connection relationships between the components or modules or signal profiles thereof are only exemplarily illustrated in FIG. 8. However, it should be understood by those skilled in the art that such related techniques as bus connection, etc., may be adopted. And the above components or modules may be implemented by hardware, such as a processor, and a memory, etc., which are not limited in the embodiment of this disclosure.

The embodiments of this disclosure are exemplarily described above; however, this disclosure is not limited thereto, and appropriate modifications may be made on the basis of the above embodiments. For example, the above embodiments may be used separately, or one or more of the above embodiments may be used in a combined manner.

It can be seen from the above embodiment that for at least two key point connection candidates in the multiple key point connection candidates, whether one of the key point connection candidates is valid is determined, so as to perform selection on the multiple key point connection candidates, and action recognition of the object is performed according to the selected key point connection candidates. In this way, the generated key point connection candidates are re-selected, which may improve accuracy of results of the action recognition in the bottom-up scheme.

### Embodiments of a Third Aspect

The embodiments of this disclosure provide an electronic device, including the action recognition device 800 as described in the embodiments of the second aspect, the contents of which being incorporated herein. The electronic device may be, for example, a computer, a server, a work station, a lap-top computer, and a smart mobile phone, etc.; however, the embodiment of this disclosure is not limited thereto.

FIG. 9 is a schematic diagram of the electronic device of an embodiment of this disclosure. As shown in FIG. 9, the electronic device 900 may include a processor 910 (such as a central processing unit (CPU)) and a memory 920, the memory 920 being coupled to the processor 910. The memory 920 may store various data, and furthermore, it may store a program 921 for information processing, and execute the program 921 under control of the processor 910.

In some embodiments, functions of the action recognition device 800 may be integrated into the processor 910. The processor 910 may be configured to carry out the action recognition method as described in the embodiments of the first aspect.

In some embodiments, the action recognition device 800 and the processor 910 are configured separately. For example, the action recognition device 800 may be configured as a chip connected to the processor 910, and the functions of the action recognition device 800 are executed under control of the processor 910.

For example, the processor 910 is configured to perform the following control; performing key point recognition on an object in a video frame by using a neural network to obtain key point information and part affinity field score(s) of the object; performing key point connection according to the key point information and the part affinity field score(s); generating multiple key point connection candidates according to a result of the key point connection; for at least two of the multiple key point connection candidates, determining whether one of the at least two key point connection candidates is valid, so as to perform selection on the multiple key point connection candidates; and performing action recognition on the object according to the selected key point connection candidates.

Furthermore, as shown in FIG. 9, the electronic device 900 may include an input/output (I/O) device 930, and a display 940, etc. Functions of the above components are similar to those in the prior art, and shall not be described herein any further. It should be noted that the electronic device 900 does not necessarily include all the parts shown in FIG. 9, and furthermore, the electronic device 900 may include parts not shown in FIG. 9, and the related art may be referred to.

An embodiment of this disclosure provides a computer readable program, which, when executed in an electric device, will cause a computer in the electronic device to carry out the action recognition method described in the embodiments of the first aspect.

An embodiment of this disclosure provides a storage medium, including a computer readable program, which will cause a computer in an electronic device to carry out the action recognition method described in the embodiments of the first aspect.

The above apparatuses and methods of this disclosure may be implemented by hardware, or by hardware in combination with software. This disclosure relates to such a computer-readable program that when the program is executed by a logic device, the logic device enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium or the memory medium may be a component of the processor. The processor and the memory medium may be located in an ASIC. The soft modules may be stored in a memory of a mobile terminal, and may also be stored in a memory card of a plug able mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

For implementations containing the above embodiments, following supplements are further disclosed.

Supplement 1. An action recognition method, including:

performing key point recognition on an object in a video frame by using a neural network to obtain key point information and part affinity field score(s) of the object;

performing key point connection according to the key point information and the part affinity field score(s);

generating multiple key point connection candidates according to a result of the key point connection;

for at least two of the multiple key point connection candidates, determining whether one of the at least two key point connection candidates is valid, so as to perform selection on the multiple key point connection candidates; and

performing action recognition on the object according to the selected key point connection candidates.

Supplement 2. The method according to supplement 1, wherein the key point recognition includes:

obtaining part affinity field information and confidence map information the object according to the key point recognition;

obtaining the key point information according to the confidence map information; and

calculating the part affinity field score(s) between any two key points according to the part affinity field information and the key point information.

Supplement 3. The method according to supplement 1 or 2, wherein the at least two key point connection candidates include a first key point connection candidate and a second key point connection candidate.

Supplement 4. The method according to supplement 3, wherein the performing selection on the multiple key point connection candidates includes:

determining whether the first key point connection candidate is valid according to a position and size of a bounding box of the first key point connection candidate and a position and size of a bounding box of the second key point connection candidate.

Supplement 5. The method according to supplement 3 or 4, wherein the performing selection on the multiple key point connection candidates includes:

according to the number of key points of the first key point connection candidate and the number of key points of the second key point connection candidate, determining whether the first key point connection candidate is valid.

Supplement 6. The method according to any one of supplements 3-5, wherein the performing selection on the multiple key point connection candidates includes:

in a case where the bounding box of the first key point: connection candidate is covered by the bounding box of the second key point connection candidate, determining whether the number of key points of the first key point connection candidate is less than a first proportion of a total number of key points of the object and determining whether the number of key points of the second key point connection candidate is greater than a second proportion of the total number of the key points of the object,

and in a case where the number of key points of the first key point connection candidate is less than the first proportion of the total number of the key points of the object and the number of key points of the second key point connection candidate is greater than the second proportion of the total number of the key points of the object, determining that the first key point connection candidate is invalid and discarding the first key point connection candidate.

Supplement 7. The method according to any one of supplements 3-6, wherein the bounding box of the first key point connection candidate is a smallest first rectangular box containing all key points in the first key point connection candidate;

and the bounding box of the second key point connection candidate is a smallest second rectangular box containing all key points in the second key point connection candidate, or the bounding box of the second key point connection candidate is a rectangular box obtained by expanding longer sides of the second rectangular box by a proportion and/or by expanding shorter sides of the second rectangular box by a proportion.

Supplement 8. A storage medium, including a computer readable program, which will cause a computer in an electronic device to carry out the action recognition method described in any one of supplements 1-7.

1. An action recognition device, characterized in that the device comprises:
a key point recognition unit configured to perform key point recognition on an object in a video frame by using a neural network to obtain key point information and part affinity field (PAF) score(s) of the object;
a key point connection unit configured to perform key point connection according to the key point information and the part affinity field score(s);
a connection candidate generating unit configured to generate multiple key point connection candidates according to a result of the key point connection;
a connection candidate determining unit configured to, for at least two of the multiple key point connection candidates, determine whether one of the at least two key point connection candidates is valid, to perform selection on the multiple key point connection candidates; and
an action recognition unit configured to perform action recognition on the object according to the selected key point connection candidates.

2. The device according to claim 1, wherein the key point recognition unit is configured to:
obtain part affinity field information and confidence map information of the object according to the key point recognition;
obtain the key point information according to the confidence map information; and
calculate the part affinity field score(s) between any two key points according to the part affinity field information and the key point information.

3. The device according to claim 1, wherein the at least two key point connection candidates comprise a first key point connection candidate and a second key point connection candidate;
and the connection candidate determining unit is configured to determine whether the first key point connection candidate is valid according to a position and size of a bounding box of the first key point connection candidate and a position and size of a bounding box of the second key point connection candidate.

4. The device according to claim 3, wherein the connection candidate determining unit is further configured to: according to the number of key points of the first key point connection candidate and the number of key points of the second key point connection candidate, determine whether the first key point connection candidate is valid.

5. The device according to claim 4, wherein the connection candidate determining unit is configured to: in a case where the bounding box of the first key point connection candidate is covered by the bounding box of the second key point connection candidate, determine whether the number of key points of the first key point connection candidate is less than a first proportion of a total number of key points of the object and determine whether the number of key points of the second key point connection candidate is greater than a second proportion of the total number of the key points of the object,
and in a case where the number of key points of the first key point connection candidate is less than the first proportion of the total number of the key points of the object and the number of key points of the second key point connection candidate is greater than the second proportion of the total number of the key points of the object, determine that the first key point connection candidate is invalid and discard the first key point connection candidate.

6. The device according to claim 3, wherein the bounding box of the first key point connection candidate is a smallest first rectangular box containing all key points in the first key point connection candidate;
and the bounding box of the second key point connection candidate is a smallest second rectangular box containing all key points in the second key point connection candidate, or the bounding box of the second key point connection candidate is a rectangular box obtained by expanding longer sides of the second rectangular box by a proportion and/or by expanding shorter sides of the second rectangular box by a proportion.

7. An action recognition method, characterized in that the method comprises:
performing key point recognition on an object in a video frame by using a neural network to obtain key point information and part affinity field score(s) of the object;
performing key point connection according to the key point information and the part affinity field score(s);
generating multiple key point connection candidates according to a result of the key point connection;
for at least two of the multiple key point connection candidates, determining whether one of the at least two key point connection candidates is valid, to perform selection on the multiple key point connection candidates; and
performing action recognition on the object according to the selected key point connection candidates.

8. The method according to claim 7, wherein the at least two key point connection candidates comprise a first key point connection candidate and a second key point connection candidate;
and the performing selection on the multiple key point connection candidates comprises: determining whether the first key point connection candidate is valid according to a position and size of a bounding box of the first key point connection candidate and a position and size of a bounding box of the second key point connection candidate.

9. The method according to claim 8, wherein the performing selection on the multiple key point connection candidates further comprises: according to the number of key points of the first key point connection candidate and the number of key points of the second key point connection candidate, determining whether the first key point connection candidate is valid.

10. An electronic device, comprising a memory and a processor, the memory storing a computer program, and the processor being configured to execute the computer program to carry out the action recognition method as claimed in claim 7.
